(19) United States
(12) Patent Application Publication
(10) Pub. No.: US 2013/0159889 A1
(43) Pub. Date: Jun. 20, 2013

(54) Obtaining Rendering Co-ordinates Of Visible Text Elements

(71) Applicants: Li-Wei Zheng, Beijing (CN); De-Miao Lin, Beijing (CN); Jian-Ming Lin, Haidian Beijing (CN); Suk Hwan Lim, Mountain View, CA (US); Jian Fan, San Jose, CA (US); Eamonn O'Brien-Strain, San Francisco, CA (US); Yuhong Xiong, Beijing (CN); Jerry J. Liu, Sunnyvale, CA (US)

(72) Inventors: Li-Wei Zheng, Beijing (CN); De-Miao Lin, Beijing (CN); Jian-Ming Lin, Haidian Beijing (CN); Suk Hwan Lim, Mountain View, CA (US); Jian Fan, San Jose, CA (US); Eamonn O'Brien-Strain, San Francisco, CA (US); Yuhong Xiong, Beijing (CN); Jerry J. Liu, Sunnyvale, CA (US)

(21) Appl. No.: 13/808,856

(22) PCT Filed: Jul. 7, 2010
(86) PCT No.: PCT/US10/75023

§ 371 Date: Jan. 7, 2013

(51) Int. Cl. G06F 3/0481

(52) U.S. Cl. CPC G06F 3/0481
USPC 715/760

(57) ABSTRACT

A computer-implemented method for obtaining the rendering co-ordinates of visible text elements on a web page is disclosed. The web page is represented by an input data structure comprising a plurality of text nodes, each of which represents a text element on the web page. The method comprises the following steps:
a) using a computer device, wrapping each of the plurality of text nodes in a pair of mark-up language tags;
b) using said computer device, obtaining the co-ordinates of a bounding rectangle for each text node using the mark-up language tags;
c) using said computer device, attaching an attribute specifying the co-ordinates of the bounding rectangle to each text node; and
d) using said computer device, determining whether each text node is invisible, and if it is, excluding it from an output data structure comprising the plurality of text nodes and attached attributes.

### BACKGROUND

Web pages typically comprise a mixture of graphical and text elements. They are defined by hypertext mark-up language (HTML) documents, which can be downloaded from a web server to a remote client for rendering by a web browser.

An HTML document is composed entirely of HTML elements, each HTML element comprising a pair of delimiting tags, zero or more attributes and the content that will be rendered by the web browser. The HTML elements may be nested. Web browsers represent the contents of an HTML document using a hierarchical data structure (or tree data structure) comprising a set of linked nodes. Each node represents an HTML element, nested elements being represented at a lower level within the hierarchical data structure (higher-level and lower-level neighbouring nodes are often referred to as “parent” and “child” nodes). The leaf (or terminal) nodes of the data structure will typically represent the content delimited by the tags. Text content within an HTML element is always stored in a text node.

This data structure is accessible via an application programming interface (API) known as the document object model (DOM). This allows a script (for example, written in JavaScript) to access each node of the data structure and perform a variety of methods on it. Thus, a script downloaded with a web page can be executed by the browser to modify the web page dynamically in response to various events such as a user clicking a button on the web page. The DOM can also be accessed to obtain information about the nodes, such as their contents and the values of any attributes associated with them.

### BRIEF DESCRIPTION OF THE DRAWINGS

For a better understanding, embodiments will now be described, purely by way of example, with reference to the accompanying drawings, in which:

FIG. 1 shows an overview of software modules for obtaining the rendering co-ordinates of visible text elements;

FIG. 2 shows the method performed by a tag wrapper module;

FIG. 3 shows the method performed by a co-ordinate calculator module; and

FIG. 4 shows the method performed by an invisible text elements filter module.

### DETAILED DESCRIPTION

There are applications where it is desirable to obtain the exact co-ordinates at which a text element is rendered by the web browser, and indeed whether the text element is visible at all.

Intelligent web printing is one such application. In this, printing software filters out unimportant contents of a web page such as advertisements and navigation bars. Information about the visible text elements is vital for segmenting the web page into blocks. Based on the exact co-ordinates and the segmentation result, important blocks are selected, merged and re-laid out for printing.

Another such application is HTML layout analysis where the block size and distance between blocks are calculated. The results are clearly more accurate if the exact co-ordinates of all elements are available.

However, obtaining accurate co-ordinates for text elements is not easy for a variety of reasons. First, the bounding box of a text element may overlap adjacent elements. Thus, the co-ordinates of the text are not co-terminous with the bounding box.

Second, a parent node may contain more than one child text node. However, according to the DOM standard the attributes of text nodes are the same as their parent nodes. Thus, each such child text node will have the same co-ordinates.

In addition, there are situations where a text element may be invisible such as when it has been scrolled off the screen, is one of the options on a closed drop-down list or is watermark text on a web page. Text is considered to be visible if it can be seen in its entirety without any user action on a rendered web page. It is vital to know whether a text element is visible in order to carry out applications such as intelligent printing or HTML layout analysis.

It might be thought that since the browser has already rendered the text elements, it would be possible to probe the internal data structure of the browser. However, many browsers do not provide the required information through an API and, in any case, it would require a different interface for each of the many browsers available.

One approach that has been suggested is to recursively calculate co-ordinates of a text node based on the co-ordinates of its ancestors (higher-level nodes in the DOM hierarchy) and various offset, dimensional and scrolling position attributes retrieved from the DOM. However, this has proven to be very slow and unreliable in practice.

It is also tempting to use the getBoundingClientRect API method provided by the DOM implemented in modern browsers. However, this method cannot provide any information regarding the visibility of a text element, or deal with the issue of parent nodes containing more than one child text node.

A first embodiment provides a computer-implemented method for obtaining the rendering co-ordinates of visible text elements on a web page represented by an input data structure (5) comprising a plurality of text nodes, each of which represents a text element on the web page, the method comprising:

a) using a computer device, wrapping (104, 105) each of the plurality of text nodes in a pair of mark-up language tags;

b) using said computer device, obtaining the co-ordinates (204, 206) of a bounding rectangle for each text node using the mark-up language tags;

c) using said computer device, attaching an attribute specifying the co-ordinates of the bounding rectangle to each text node; and

d) using said computer device, determining whether each text node is invisible (302, 304), and if it is, excluding (303) it from an output data structure (6) comprising the plurality of text nodes and attached attributes.

Hence, by wrapping each text node in a pair of mark-up language tags, the embodiment effectively provides a temporary parent node for each text node. The co-ordinates of the text node can then be accurately obtained based on the mark-up language tags, i.e. the temporary parent node. The end result is a data structure containing details of the text nodes and their co-ordinates, and in which the invisible text nodes are filtered out.

An embodiment provides a computer program comprising a set of computer-readable instructions adapted, when executed on a computer device, to cause said computer device to obtain the rendering co-ordinates of visible text elements on a web page represented by an input data structure (5) comprising a plurality of text nodes, each of which represents a text element on the web page, by a method comprising:

a) using said computer device, wrapping (104, 105) each of the plurality of text nodes in a pair of mark-up language tags;

b) using said computer device, obtaining the co-ordinates (204, 206) of a bounding rectangle for each text node using the mark-up language tags;

c) using said computer device, attaching an attribute specifying the co-ordinates of the bounding rectangle to each text node; and

d) using said computer device, determining whether each text node is invisible (302, 304), and if it is, excluding (303) it from an output data structure (6) comprising the plurality of text nodes and attached attributes.

Another embodiment provides a computer-readable medium having computer-executable instructions stored thereon that, if executed by a computer device, cause the computer device to obtain the rendering co-ordinates of visible text elements on a web page represented by an input data structure (5) comprising a plurality of text nodes, each of which represents a text element on the web page, by a method comprising:

a) using said computer device, wrapping (104, 105) each of the plurality of text nodes in a pair of mark-up language tags;

b) using said computer device, obtaining the co-ordinates (204, 206) of a bounding rectangle for each text node using the mark-up language tags;

c) using said computer device, attaching an attribute specifying the co-ordinates of the bounding rectangle to each text node; and d) using said computer device, determining whether each text node is invisible (302, 304), and if it is, excluding (303) it from an output data structure (6) comprising the plurality of text nodes and attached attributes.

Typically, in the above embodiments, the mark-up language tags will be HTML tags.

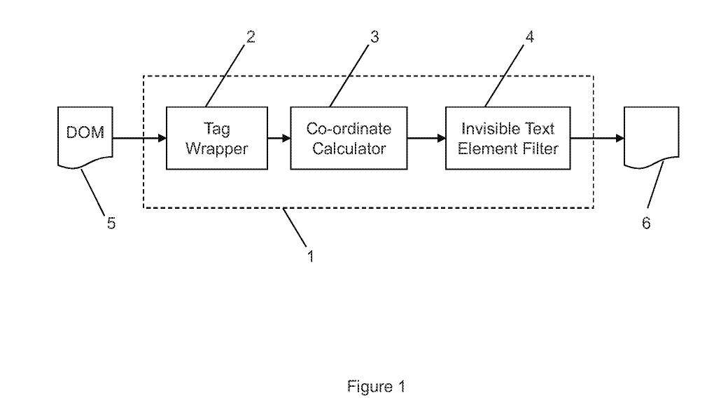

A broad overview of software for performing the method of the first embodiment is illustrated in FIG. 1. In this, a software product 1 for obtaining the rendering co-ordinates of visible text elements on a web page comprises three modules: a tag wrapper module 2, a co-ordinate calculator module 3, and an invisible text element filter 4.

The modules 2, 3, 4 work together to produce a data structure containing details of the text nodes and their co-ordinates, in which the invisible text nodes are filtered out.

To do this, the tag wrapper module 2 queries each text node of a data structure 5 representing a web page rendered by a browser using the DOM API. Thus, the tag wrapper module 2 waits until any Cascading Style Sheet (CSS) information has been applied to the HTML and until any scripts (such as JavaScript) have been executed. It then wraps each text node in a pair of HTML tags. It produces a JavaScript Object Notation (JSON) data structure as output, which comprises all the text nodes wrapped in the HTML tags (along with all the other nodes representing the HTML). Under some circumstances, as described below, the web page may be re-rendered to incorporate the wrapped text nodes correctly. If this is done then the tag wrapper module 2 adds the pairs of HTML tags to the text nodes in the data structure 5 via the DOM API and then instructs the browser to re-render the web page including the additional pairs of HTML tags.

The JSON data is then received by the co-ordinate calculator module 3. The co-ordinate calculator module 3 then obtains co-ordinates for each text node and attaches them as attributes to the data structure 5 via the DOM API.

Lastly, the invisible text element filter 4 determines whether each text node is invisible and if it is, it excludes the text element from an output data structure 6, which is in the form of a list of visible text nodes to which are attached the co-ordinates calculated by co-ordinate calculator module 3 (along with any other attributes already present from the original data structure 5). Alternatively, or in addition, the data structure 5 may be modified by deletion of the invisible text nodes.

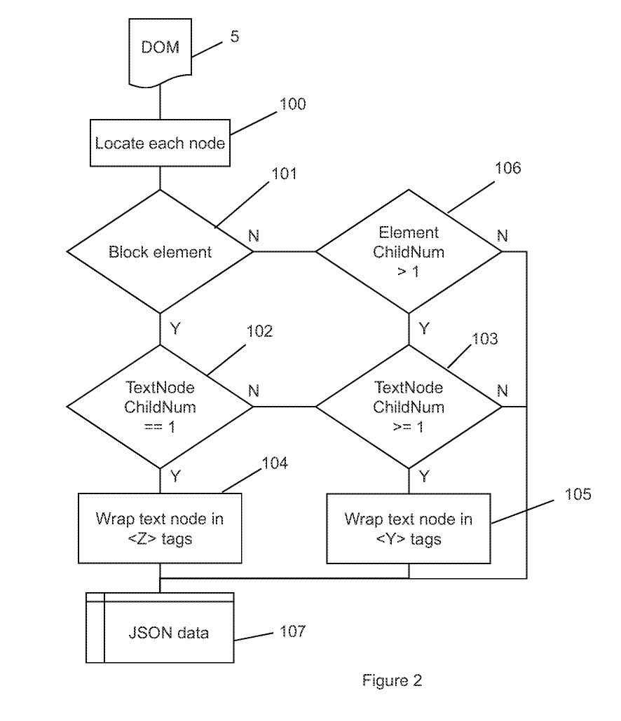

The steps performed by each software module 2, 3, 4 will now be described with reference to FIGS. 2, 3 and 4 respectively.

FIG. 2 shows a flow chart of the steps carried out by the tag wrapper module 2. First, in step 100, the tag wrapper module 2 traverses the data structure 5 representing the rendered web page via the DOM API to locate each node in turn. As explained above, the input data structure 5 is a hierarchical arrangement of nodes comprising a plurality of text nodes and at least one element node representing an HTML element, each of which may have one or more text nodes as a lower-level neighbour (a child) in the hierarchy.

Each node is assessed in step 101 to see whether it is a node representing an HTML block element (for example, a <P> or <DIV> tag). If such a node is found then step 102 determines whether there is only one lower-level neighbouring text node. If there is, then in step 104 it is wrapped in HTML <Z> tags. If it is found that there is not only one lower-level neighbouring text node then step 103 determines whether there is one or more lower-level neighbouring text nodes. If there is then each of these lower-level neighbouring text nodes is wrapped in <Y> tags in step 105. Of course, if step 103 determines that there is one or more lower-level neighbouring text nodes then this inherently means that there is more than one because step 102 has already determined that there is not only one lower-level neighbouring text node.

Alternatively, if the node does not represent an HTML block element then in step 106, an assessment is made as to whether the node has more than one lower-level neighbouring (child) node. If it does then, in step 103, each child node is assessed to determine whether it is the first or subsequent text node. If it is then it is wrapped in <Y> tags in step 105.

Thus, the data structure 5 is modified by wrapping the text nodes in <Z> and <Y> tags appropriately.

The tag wrapper module 2 also generates a JSON data structure 107, which comprises the text nodes wrapped in <Z> and <Y> tags as appropriate. Use of a JSON data structure to communicate between the tag wrapper module 2 and the co-ordinate calculator module 3 is beneficial because it is easier to manipulate JSON data than the data structure 5 representing the web page through the DOM API using JavaScript. Also the DOM implementation differs between browsers, whereas handling of JSON data is more consistent.

Thus, the method performed by the tag wrapper module 2 ensures that for each element node representing an HTML block element having only one lower-level neighbouring text node, the lower-level neighbouring text node is wrapped in a pair of HTML tags of a first type (in this case, <Z> tags). For each element node representing an HTML block element having more than one lower-level neighbouring text node, each of the lower-level neighbouring text nodes is wrapped in a pair of HTML tags of a second type (in this case, <Y> tags).

Furthermore, for each node representing an HTML non-block element and having more than one lower-level neighbouring text node, each such lower-level neighbouring text node is wrapped in a pair of HTML tags of the second type.

The particular choice of <Z> and <Y> tags for tags of the first and second types is, to a certain extent, arbitrary. In this case, HTML tags that are undefined by the W3C HTML standards have been selected so that they are ignored by the web browser during rendering. They ensure that each text node has a well-defined parent to enable its co-ordinates to be retrieved through the DOM API.

The web page including the wrapped text nodes may be re-rendered subsequent to wrapping each text node in a pair of HTML tags. This is typically only done if at least one text node has been wrapped in a pair of HTML tags of the second type (i.e. in <Y> tags). Re-rendering is not performed (at least with most DOM APIs) when only <Z> tags have been used because the co-ordinates of the single text node will already have been calculated by the rendering engine; the insertion of the <Z> tags merely provides a handle to obtain the co-ordinates via the DOM API.

Rendering is a time consuming operation. By using the two types of tag, it is possible to limit the instances in which the re-rendering step is carried out.

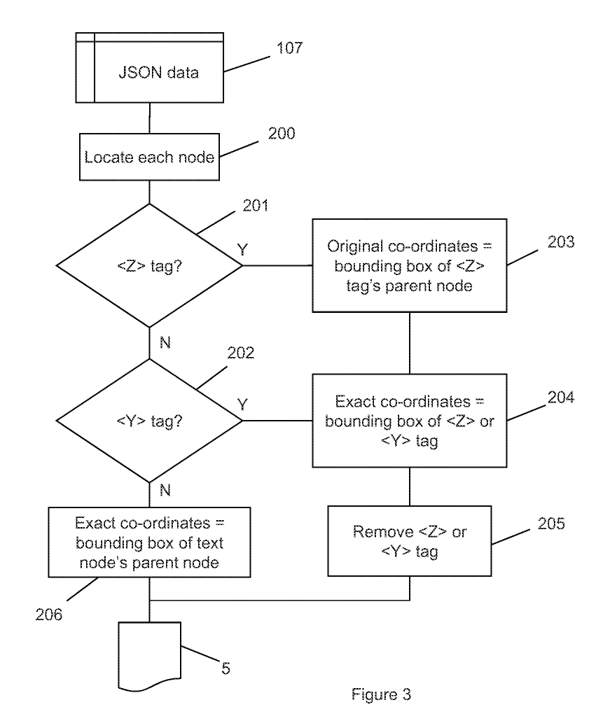

FIG. 3 illustrates the operation of the co-ordinate calculator module 3. This receives the JSON data structure 107 and traverses the JSON data structure 107 in step 200. Each node is then assessed to see whether it has a <Z> tag or a <Y> tag in steps 201 and 202 respectively,

If a <Z> tag is found then, in step 203, the co-ordinates of the bounding box of the <Z> tag's higher-level neighbouring (parent) element node are retrieved from data structure 5 using the getBoundingClientRect DOM API method. These co-ordinates are attached as an attribute to the text node wrapped by the <Z> tag via the DOM API. Thus, an attribute specifying the co-ordinates of the bounding rectangle of a higher-level neighbouring element node is attached to each text node wrapped in a pair of HTML tags of the first type.

In step 204, the co-ordinates of the bounding box of the text node wrapped by the <Z> tag are retrieved from data structure 5 using the getBoundingClientRect DOM API method. These co-ordinates are also attached as an attribute to the text node wrapped by the <Z> tag via the DOM API.

If a <Y> tag is found then, in step 204, the co-ordinates of the bounding box of the text node wrapped by the <Y> tag are retrieved from data structure 5 using the getBoundingClientRect DOM API method. These co-ordinates are attached as an attribute to the text node wrapped by the <Y> tag via the DOM API.

In step 205, the <Z> and <Y> tags are removed via the DOM API.

If neither a <Z> or a <Y> tag is wrapped around a text node then the co-ordinates of the bounding box of the <Z> tag's higher-level neighbouring (parent) element node are retrieved from data structure 5 using the getBoundingClientRect DOM API method.

By manipulating the data structure 5 via the DOM API to attach the co-ordinates as attributes to the text nodes in steps 203, 204 206, the data structure 5 is modified so that it comprises all of the text nodes with attributes specifying the exact co-ordinates of their bounding boxes as rendered.

Two new methods, getExactCoordinates and getOriginalCoordinates, are added to the DOM API to enable the calculated co-ordinates and the original co-ordinates to be retrieved later.

The original co-ordinates of a text node may be useful as they may contain alignment information, which can be useful for paragraph detection (and indeed, detection of other content). For example, successive paragraphs may have bounding boxes with original co-ordinates that align at both the left and right hand sides, and this can be used to detect paragraphs.

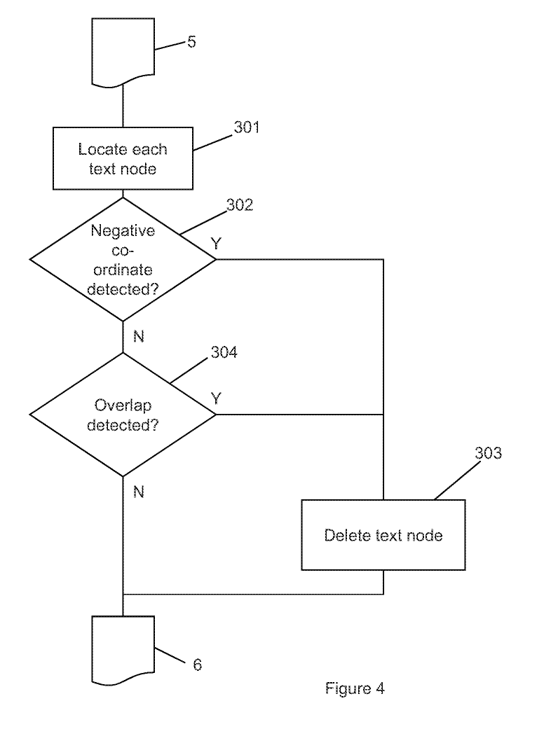

FIG. 4 shows a flow chart explaining the operation of the invisible text element filter module 4. This traverses the modified data structure 5 in step 301 to locate each text node. The co-ordinates of each text node are then retrieved from the data structure 5 using the getExactCoordinates method previously added to the DOM API.

A data structure comprising a list of the located text nodes along with their co-ordinates and other associated attributes is constructed. Each of the text nodes in the list is then analysed as described below.

If a text node is found to have a negative value for any of the co-ordinates of its bounding rectangle in step 302 then the text node is deleted from the list in step 303. Thus, a text node is determined to be invisible if it has a negative value for any of the co-ordinates of its bounding rectangle.

If the text node has positive co-ordinates then, in step 304, its bounding box is assessed relative to that of the neighbouring higher-level (parent) node. If it is found to be equal to the bounding box of the neighbouring higher-level node then it is assessed relative to the bounding box of the grandparent node. If it is found to be equal to the bounding box of the grandparent node then it is assessed relative to the bounding box of the great-grandparent node. If the text node's bounding box overlaps any of the parent's, grandparent's or great-grandparent's bounding box by more than a predetermined threshold then it is deleted from the list in step 303. Thus, a text node is determined to be invisible if its bounding rectangle overlaps the bounding rectangle of a higher-level node by more than a predetermined threshold.

The predetermined threshold may be zero, or it may provide a slight tolerance, for example 25 pixels.

The resultant output is a data structure 6, which is a list comprising all of the visible text nodes along with attributes giving their exact rendering co-ordinates and others of their attributes retrieved from data structure 5 via the DOM API.

Using the output data structure 6, it is possible for an intelligent web printing application to allow a user to select elements (including text elements) of a web page for printing and from information about the exact rendering co-ordinates of the selected elements and their visibility in the output data structure 6, render the selected elements only and print them.

1. A computer-implemented method for obtaining the rendering co-ordinates of visible text elements on a web page represented by an input data structure comprising a plurality of text nodes, each of which represents a text element on the web page, the method comprising:
a) using a computer device, wrapping each of the plurality of text nodes in a pair of mark-up language tags;
b) using said computer device, obtaining the co-ordinates of a bounding rectangle for each text node using the mark-up language tags;
using said computer device, attaching an attribute specifying the co-ordinates of the bounding rectangle to each text node; and
d) using said computer device, determining whether each text node is invisible, and if it is, excluding it from an output data structure comprising the plurality of text nodes and attached attributes.

2. A method according to claim 1, wherein the mark-up language is hypertext mark-up language (HTML) and the input data structure is a hierarchical arrangement of nodes comprising the plurality of text nodes and at least one element node representing an HTML element, each of which may have one or more of the text nodes as a lower-level neighbour in the hierarchy, and wherein step (a) comprises:
i) for each element node representing an HTML block element and having only one lower-level neighbouring text node, wrapping the lower-level neighbouring text node in a pair of HTML tags of a first type;
ii) for each element node representing an HTML block element and having more than one lower-level neighbouring text node, wrapping each such lower-level neighbouring text node in a pair of HTML tags of a second type; and
ii) for each node representing an HTML non-block element and having more than one lower-level neighbouring text node, wrapping each such lower-level neighbouring text node in a pair of HTML tags of the second type.

3. A method according to claim 1, further comprising generating Javascript Object Notation (JSON) data defining the wrapped text nodes prior to step (b).

4. A method according to claim 1, wherein step (a) comprises rendering the web page including the wrapped text nodes subsequent to wrapping each text node in a pair of mark-up language tags.

5. A method according to claim 2, wherein step (a) comprises rendering the web page including the wrapped text nodes subsequent to wrapping each text node in a pair of HTML tags only if at least one text node has been wrapped in a pair of HTML tags of the second type.

6. A method according to claim 2, further comprising attaching an attribute specifying the co-ordinates of the bounding rectangle of a higher-level neighbouring element node to each text node wrapped in a pair of HTML tags of the first type in step (c).

7. A method according to claim 1, further comprising removing each pair of mark-up language tags after step (c).

8. A method according to claim 1, wherein step (d) comprises determining that a text node is invisible if it has a negative value for any of the co-ordinates of its bounding rectangle.

9. A method according to claim 2, wherein step (d) comprises determining that a text node is invisible if its bounding rectangle overlaps the bounding rectangle of a higher-level node by more than a predetermined threshold.

10. A method according to claim 9, wherein the predetermined threshold is zero.

11. A method according to claim 1, wherein the output data structure is in the JSON format.

12. A method according to claim 1, wherein the pair of mark-up language tags used to wrap each text node in step (a) are HTML tags, which are undefined by the W3C HTML standards.

13. A method according to claim 2, wherein the HTML tags of the first and second types are undefined by the W3C HTML standards.

14. A computer program comprising a set of computer-readable instructions adapted, when executed on a computer device, to cause said computer device to obtain the rendering co-ordinates of visible text elements on a web page represented by an input data structure comprising a plurality of text nodes, each of which represents a text element on the web page, by a method comprising;
a) using said computer device, wrapping each of the plurality of text nodes in a pair of mark-up language tags;
b) using said computer device, obtaining the co-ordinates of a bounding rectangle for each text node using the mark-up language tags;
c) using said computer device, attaching an attribute specifying the co-ordinates of the bounding rectangle to each text node; and
d) using said computer device, determining whether each text node is invisible, and if it is, excluding it from an output data structure comprising the plurality of text nodes and attached attributes.

15. A computer-readable medium having computer-executable instructions stored thereon that, if executed by a computer device, cause the computer device to obtain the rendering co-ordinates of visible text elements on a web page represented by an input data structure comprising a plurality of text nodes, each of which represents a text element on the web page, by a method comprising;
a) using said computer device, wrapping each of the plurality of text nodes in a pair of mark-up language tags;
b) using said computer device, obtaining the co-ordinates of a bounding rectangle for each text node using the mark-up language tags;
using said computer device, attaching an attribute specifying the co-ordinates of the bounding rectangle to each text node; and
d) using said computer device, determining whether each text node s invisible, and if it is, excluding it from an output data structure comprising the plurality of text nodes and attached attributes.
